(19) United States
(12) Patent Application Publication
(10) Pub. No.: US 2007/0033180 A1
(43) Pub. Date: Feb. 8, 2007

(54) Apparatus and method for searching for software units for use in the manufacturing industry

(75) Inventors: Nobumasa Nakano, Tokyo (JP); Eiji Yamamoto, Tokyo (JP); Masaru Nagashima, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION

(21) Appl. No.: 11/498,784

(22) Filed: Aug. 4, 2006

(30) Foreign Application Priority Data
Aug. 5, 2005 (WO) PCT/JP05/14450
Jun. 7, 2006 (JP) 2006-158349

(51) Int. Cl. G06F 17/30

(52) U.S. Cl. 707/4

(57) ABSTRACT

A unit property for defining the manufacturing industry software unit is described with the use of the action of an access to a domain concept data model element of an activity that is realized by the software unit described in an implementation specification format. As a result, the manufacturing industry software unit can be formally described as the property that defines the action of the description when it is described by using the software unit profiling template described in the implementation specification format defined by ISO 16100-2. Also, a request in conducting retrieval can be described in the same format as the above, and the process semantics of the existing manufacturing industry software unit can be efficiently registered in the directly expressed and in a common form, and effectively retrieved.

### BACKGROUND OF THE INVENTION

1. Field of the Invention

The present invention relates to a searching apparatus (or retrieval device) and a searching method (or retrieval method) for a software unit for a manufacturing industry, and more particularly to a searching apparatus and a searching method for a software unit for use in a manufacturing industry, which are capable of registering and retrieving the existing software unit with high efficiency.

2. Description of the Related Art

In recent years, there has been proposed and spread a flexible production system having a structure in which devices to be controlled and a control device are connected to each other on a network. The devices to be controlled include diverse machine tools, which actually conduct machining, cleaning, or transport of a workpiece as production facilities, setup device, cleaning device, operation instruction device, and transport device. The control device controls those devices to be controlled overall while processing basic information such as machining scheduling, machining procedure information, and to-be-used jig information for operating the devices to be controlled, and then preparing an operation schedule.

In order to drive the above-mentioned production system, dedicated or general-purpose software is required. In addition, in order to efficiently create a specified field (hereinafter referred to as “domain”) acceptable production system, the specified domain acceptable production process, that is, a device that embodies the production activity that constitutes the specified domain acceptable production process, one or a plurality of software components for driving those devices, and the specification of the computer environment in which those devices drive are integrated, and the development of a software unit (i.e., automation object) for the manufacturing industry activity has been actively conducted. In the development of the software unit, in order to improve the efficiency of the development, there has been used a method in which the existing software components are recycled without any modification or with being partially modified or added, thereby deleting the number of software components to be newly developed, or the number of developing steps of software. Hereinafter, the software unit is called “software unit for manufacturing industry”.

However, up to now, (1) there has been provided no software unit for manufacturing industry and no unit profile registration schema that registers the software unit for manufacturing industry serving as a so-called software component, from the viewpoints of recycling the software unit for manufacturing industry in an appropriate retrieval device, and specifies the meaning, definition, and attribute of the software unit for manufacturing industry, which constitute a base for use of the retrieval device serving as the retrieval mean, as a so-called profile. Also, (2) there has been provided no specification and method that formally describe the meaning, definition, and attribute of the software unit for manufacturing industry in a computer-comprehensible format by a top-down system. As a result, both of registration and retrieval of the software components are always conducted through a determination by an operator, so, the above-mentioned software unit cannot be automated to thereby being ineffective, and utility of the software components is limited (for example, refer to JP 06-348471 A and JP 11-157329 A). The registration retrieval system having the above-mentioned features is named “meaning model-less arbitrary registration retrieval system”.

Meanwhile, for example, as typified by the standardization of the ASAM CEA group which is a consortium of German automobile industry, the details of a group problem area manufacture application process are modeled as an activity that realizes the process in advance, the modeled process is regarded as an original drawing of a jigsaw puzzle, and the activity model corresponding to each piece or a plurality of specific blocks consisting of the arbitrary combination of those pieces is denominated as a specific standard module. Then, the activity model is registered in a retrieval device as a name thereof, and used as implementation process correspondence activity model of the corresponding request/existing module. The original model, various standard module names, and correspondence activity models are shared as a request specification of the application system shared by user members of the consortium, an application module division specification provided by a vender as a consortium member, and an activity model to be implemented therein. The original model, various standard module names, and correspondence activity models are developed and operated to effectively put software unit for manufacturing industry related to the consortium into practice.

The above-mentioned system is capable of explicitly representing the software unit or the required detailed specification as a model, and therefore is excellent in the efficiency. However, the system suffers from such a problem that the architectures of the application software (e.g., the detailed specification of the overall activity, the module division thereof, and the module structure thereof) are unambiguously determined, and therefore the optimum function system required by the user cannot be freely combined together and constructed. Further, the degree of freedom that the vender freely constructs the application of the subject field according to the vender's business strategy is lack. The registration retrieval system having the above-mentioned features is named “application meaning model dependent name registration retrieval system”.

In addition, through both of those systems, there is a system in which the profile template for manufacturing industry defined by ISO 16100-2:2004 is used for expression as the profile obtained by substituting the attribute defined by the template with an instance value, to thereby achieve the efficiency of the retrieval of the software unit for manufacturing industry which is implemented for the required specification. However, in the template defined by ISO 16100-2:2004, as the above-mentioned ASAM CEA group adopts, for the meaning of the function of the software unit, the existing problem area is considered as a corresponding process activity model drawing and a partial model corresponding to a unit consisting of the partial combination of the pieces of the jigsaw puzzle, and is managed by its name. The registration retrieval system is of the above-mentioned application model dependent name registration retrieval system. The understanding of the subject process embodied by the software unit for manufacturing and the execution contents of its implementation activity complies with the jigsaw puzzle. Therefore, a person must conduct determination while viewing the model drawing as a part of the jigsaw puzzle, and it is impossible to conduct retrieval based on the meaning understanding of the activity model by a computer.

In the meaning model-less arbitrary registration retrieval system, the execution contents of the process of the application are not directly defined. Instead, for example, an integral made of an existing proposal, specification, project book, and the like constitutes the semantics of the execution contents of the application process as the integral (for example, refer to JP 06-348471 A). Also, more positively, unspecified majority of attribute values such as the application form, the applied field, or the application information repository are devised, and the semantics of the application process is defined as its integral (for example, refer to JP 11-157329 A). Those systems conduct indirect semantic expression

In the latter application meaning model dependent name registration retrieval system, there is applied a system that directly prevents the description of semantics in which the model drawing that expresses the process integral of the application is broken into a top-down system, the respective block elements are denominated, and the names constitute the indexes of the original model drawings. The system does not include formal description in which retrieval with ease such as automatic retrieval of a meaning model base by a computer.

In other words, as is apparent from the above-mentioned representative two systems for registration and retrieval system of the software unit for manufacturing industry, there has not yet been presently established a technique in which the semantics related to an activity corresponding to execution contents of the application process that is executed by the respective software units are defined directly and in a common form, and the registration and retrieval of the software unit can be efficiently conducted.

What is demanded as the registration and retrieval system of the software unit is a system in which a semantics description format that is related to an activity model corresponding to the contents of the application process that is executed by the respective software units are defined directly and in the common form, and the registration and retrieval of the software unit for manufacturing industry can be efficiently conducted, as a registration retrieval system that transcends the above-mentioned meaning model-less arbitrary registration retrieval system and the application meaning model dependent name registration retrieval system. In particular, in the case where the application field of a user and a vender is limited such as consortium, there is a case in which limited conditions are that the domain concept data model corresponding to the field and the problem area is to be standardized and the software unit that embodies the arbitrary application is then constituted. The domain concept data model corresponding to the problem area is an assembly including objects and the relations between the objects. The objects collectively represent data regarded as standards which abstract a plurality of activities from the application model corresponding to the problem area (the activity is to be accessed), the data structure, the operation therefor, and an interface to the operation. Because the domain concept data model presents almost every meaning and contents of a business object corresponding to the domain problem as the model by itself, the domain concept data model strictly defines the semantics of the objects related to the problem area of the domain. As the demanded registration retrieval system, the software vender is capable of formally and efficiently registering the meaning of the activity that is embodied by the software unit for manufacturing industry on the basis of the related domain concept data. Also, the user of the software unit for manufacturing industry is capable of formally describing the function request of the required application on the basis of the element data assembly of the concept data model in which the activity to be embodied will be involved, and the concept data model as the common semantics of the domain in constructing a new application, thereby making it possible to efficiently retrieve the existing software unit that has been registered by the vender.

### SUMMARY OF THE INVENTION

The present invention has been made to solve the above-mentioned problems, and therefore an object of the present invention is to provide a retrieval device and a retrieval method for a manufacturing industry software unit which are capable of effectively registering and also effectively retrieving the semantics of a process of the existing manufacturing industry software unit and an activity that embodies the process in a directly expressed and in the common form.

According to the present invention, there is provided a retrieval device for a manufacturing industry software unit, including: input means for inputting one of a manufacturing industry software unit and a required specification to be retrieved which are described as a software unit profile of the implementation specification form and the software unit property, which share the domain concept data model of the specified field as the semantics and use the model element of the domain concept data model; memory means for storing the software unit profile and the software unit property of the manufacturing industry software unit which are inputted; retrieval means for retrieving and extracting the manufacturing industry software unit that conforms to the requested specification from the memory means; and output means for outputting the retrieval result in the retrieval means to the external.

According to the present invention, there is provided a retrieval device for a manufacturing industry software unit, comprising: input means for inputting one of a manufacturing industry software unit and a required specification to be retrieved which are described as a software unit profile of the implementation specification form and the software unit property, which share the domain concept data model of the specified field as the semantics and use the model element of the domain concept data model; memory means for storing the software unit profile and the software unit property of the manufacturing industry software unit which are inputted; retrieval means for retrieving and extracting the manufacturing industry software unit that conforms to the requested specification from the memory means; and output means for outputting the retrieval result in the retrieval means to the external. With the above-mentioned structure, the semantics of a process of the existing manufacturing industry software unit and an activity that embodies the process in a directly expressed and in the common form can be effectively registered and also effectively retrieved.

### BRIEF DESCRIPTION OF THE DRAWINGS

In the accompanying drawings:

FIG. 1 is a block diagram showing a structure of the registration/retrieval device for a manufacturing industry software unit profile+ according to a first embodiment of the present invention;

FIG. 2-1 is a flowchart for explaining a general acquisition flow for explaining a specified domain correspondence concept data model assumed in the retrieval device according to the first embodiment of the present invention;

FIG. 2-2 is a flowchart for explaining the registration flow of the software unit profile+ that is projected, designed, and manufactured on a domain concept data model;

FIG. 2-3 is a flowchart for explaining the retrieval flow of the existing manufacturing industry software unit in the project and design of a new manufacturing industry software unit;

FIG. 2-4 is an explanatory diagram showing an example of a unit profile schema;

FIG. 2-5 is an explanatory diagram showing an example of a profiled unit profile schema;

FIG. 3 is a block diagram showing a manufacturing form that is controlled by the manufacturing industry software unit according to an embodiment;

FIG. 4 is a diagram showing an implemented activity assembly which describes the software unit profile+ of the manufacturing industry software unit in a specified production system, as well as an activity structure diagram which includes a structure showing a positioning and a correlation among the assembly of the respective activities, i.e., the respective software units. It should be noted that the specified production system is constructed in a use case of a specified domain and a domain concept data model shown in FIGS. 5, 6-1, and 6-2 described below;

FIG. 5 is a diagram showing a part of a use case drawing of the domain correspondence application as an example;

FIG. 6-1 is a diagram showing the domain concept data model that is acquired by the use case (only partially) shown in FIG. 5;

FIG. 6-2 is a diagram showing a result of converting the domain concept data model with reference to a translation table;

FIG. 7-1 is a diagram showing an access relationship between a specified activity structure within the implemented activities that describe the manufacturing industry software unit corresponding to the specified production system shown in FIG. 4, and the activity within the structure, and a domain concept data model element that is accessed from the activity;

FIG. 7-2 is a diagram showing an access relationship between a specified activity structure within the implemented activities that describe the manufacturing industry software unit corresponding to the specified production system shown in FIG. 4, and the activity within the structure, and a domain concept data model element that is accessed from the activity;

FIG. 8 is a diagram for classifying and explaining the access forms of the access such as the other activity and the access of the concept data model element in the respective activities that constitute the production system (i.e., process) shown in FIG. 4;

FIG. 9 is a diagram showing an example in which the activity (to be realized by the software unit) is property-described with the use of the model element of the domain concept data model;

FIG. 10 is a diagram for explaining an action series of the activity (to be realized by the software unit), a correspondence of the domain concept data element that is accessed by the respective action series, and a property describing method that is described on the basis of the correspondence;

FIG. 11 is a diagram showing a flow of the process in the case where the requested activity profile+ described in a different description form is inputted; and

FIG. 12 is a diagram showing an example of a translation table.

### DETAILED DESCRIPTION OF THE PREFERRED EMBODIMENTS

Now, a description will be given in more detail of preferred embodiments of the present invention with reference to the accompanying drawings.

### First Embodiment

The present invention is characterized by including, in the existing software unit: input means for inputting a set of the manufacturing industry software unit profile that is described on the basis of the profile template defined by ISO 16100-2 and the element data of the domain concept data model that is access by the activity which is embodied by the software unit, the existing manufacturing industry software unit profile constituted of the process of the software unit and the software unit property that is formally described as the action semantics of the embodied activity on the basis of the action in the access, and the requested software unit property that is formally described on the basis of the profile that is described on the basis of the ISO 16100-2 rule with respect to the manufacturing industry software unit demanded by the requested specification correspondence in response to the above, the element data set of the domain concept data model to be accessed by the embodied activity, and the action in the access; storage means for storing the software unit profile of the inputted existing manufacturing industry software unit and the software unit property; retrieval means for retrieving and extracting the manufacturing industry software unit that conforms to the requested specification from the memory means; and output means for outputting a result of the retrieval performed by the retrieval means to the external.

The present invention provides the property that is formally described and produced by the access contents to the manufacturing industry software unit to be accessed as the lower-level activity which is nested within the subject domain concept data model element or within the implementation activity with the profile of the manufacturing industry software unit as the property (hereinafter referred to as “function property”) which describes the function contents of the implementation activity of the software unit, in addition to the profile that is produced with the use of the unit profiling template defined by ISO 16100-2. In the present invention, the property description is added, thereby making it possible to effectively register and also effectively retrieve the semantics of a process of the existing manufacturing industry software unit and the embodied activity by means of the domain concept data model as the semantics common to the domain in a directly expressed and common format, which produces an effect of improving the development efficiency of the new manufacturing industry software unit. Hereinafter, the profile written in the ISO 16100-2 template format including the property description thus described is inscribed as “new manufacturing industry software unit profile+”, so that it can be distinguished from the profile simply written in ISO 16100-2 template format. Also, there exist two kinds of existing and required manufacturing industry software unit profiles+.

Hereinafter, a description will be given in more detail of embodiments of the retrieval device and the retrieval method for the manufacturing industry software unit (hereinafter simply referred to as “software unit”) according to the present invention with reference to the accompanying drawings. The present invention is not limited to the following description, and can be appropriately modified within a range that does not deviated from the gist of the present invention.

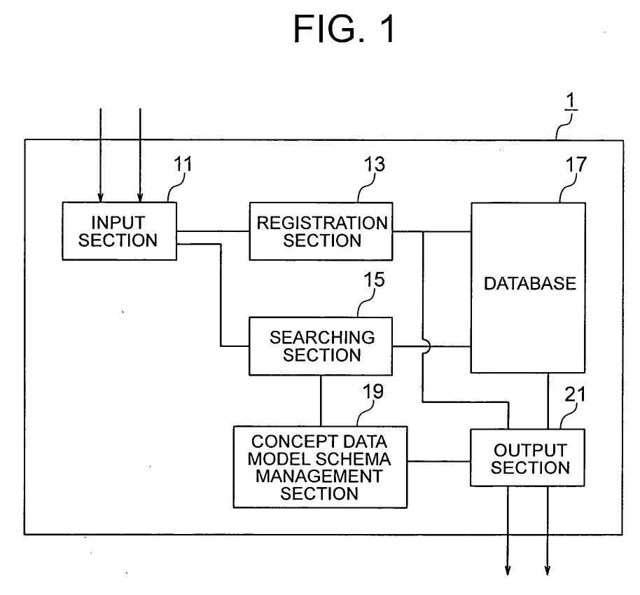

FIG. 1 is a block diagram showing the structural example of a retrieval device (hereinafter simply referred to as “retrieval device”) for a software unit according to a first embodiment of the present invention. As shown in FIG. 1, the retrieval device 1 according to the present invention includes an input section 11, a registration section 13, a searching section 15 (or retrieval section), a database 17, a concept data model schema management section 19, and an output section 21.

In this example, the input section 11 is means for conducting an input process for inputting, to the retrieval device 1, the existing software unit profile+ described as an implementation specification for the application of a software unit (or a software part) to an actual device, which is to be registered in the database 17. Also, the input section 11 is means for inputting the requested software profile+ as the requested specification of the software unit having a desired execution function (activity) in retrieving the software unit having the desired execution function (activity) from the existing software unit profile+ that has been registered in the database 17.

The registration section 13 is means for conducting a registration process for registering, in the database 17, the software unit profile+ which has been inputted by the input section 11 and is to be registered in the database 17. The registration section 13 may include a function of confirming whether an object to be registered has been described in a given format, or not. With provision of the above-mentioned function, the registration section 13 is capable of surely registering only a desired software unit profile+ that is described in the given format, in the database 17, thereby improving the retrieval efficiency. Also, in the case where the object to be registered has not been described in the given format, the registration section 13 is capable of transmitting information indicating that the object to be registered has not been described in the given format, to the output section 21.

The searching section 15 is means for conducting a retrieval process for searching the database 17 to check whether the software unit (or the software part) that conforms to the software unit profile+ as the requested specification has been registered, or not, on the basis of the requested specification inputted from the input section 11. Then, in the case where the subject software unit (or the software part) has been registered in the database 17, the searching section 15 transmits the subject data to the output section 21. Also, in the case where the subject software unit (or the software part) has not been registered in the database 17, the searching section 15 transmits information indicating that there is no subject data, to the concept data model schema management section 19.

The database 17 is memory means for storing the software unit profile+ that has been inputted from the input section 11 and registered in the registration section 13.

The concept data model schema management section 19 transmits the information indicating that the subject data should be newly registered, to the output section 21 in the case where the new concept data model element or the software unit of a middle level (lower level) which is to be newly nested is included within the description of the software unit profile+ of the software unit (or the software part) corresponding to the requested specification.

Also, the concept data model schema management section 19 transmits the information indicating that the subject data should be newly registered, to the output section 21, even in the case where the combination of new domain concept data model elements, or the order of the new domain concept data model element is included within the property description of the software unit (or the software part) corresponding to the requested specification.

The output section 21 is means for outputting the retrieval result that has been transmitted from the searching section 15 to the external. For example, the output section 21 outputs the retrieval result to a display device or a printing device which is connected to the output section 21. The display device or the printing device displays or prints the outputted retrieval result. As a result, the user is capable of confirming the retrieval result.

Also, in the case of receiving information, from the registration section 13, indicating that the object to be registered has not been registered in the given format, the output section 21 is capable of outputting the information to a display device or a printing device (not shown) which is connected to the output section 21. The display device or the printing device displays or prints the outputted retrieval result. As a result, the user is capable of obtaining the information indicating that the object to be registered has not been registered in the given format.

In addition, in the case of receiving the information transmitted from the concept data model schema management section 19, indicating that the data should be newly registered, the output section 21 is capable of outputting the information to the display device, the printing device, or the like, which is connected to the output section 21. The display device or the printing device displays or prints the outputted information. As a result, the user is capable of newly recognizing the necessity of the data registration.

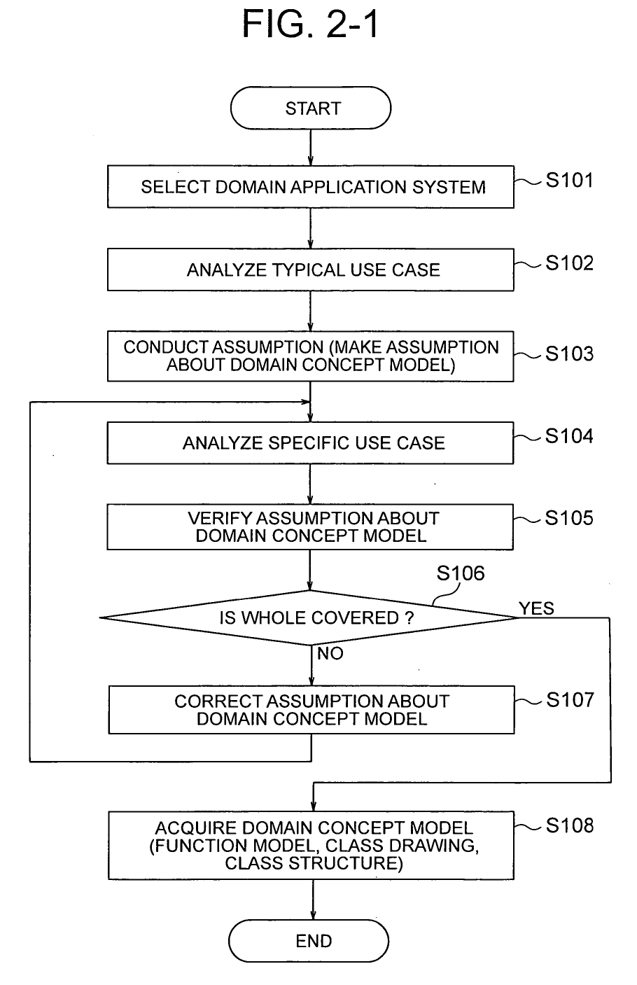

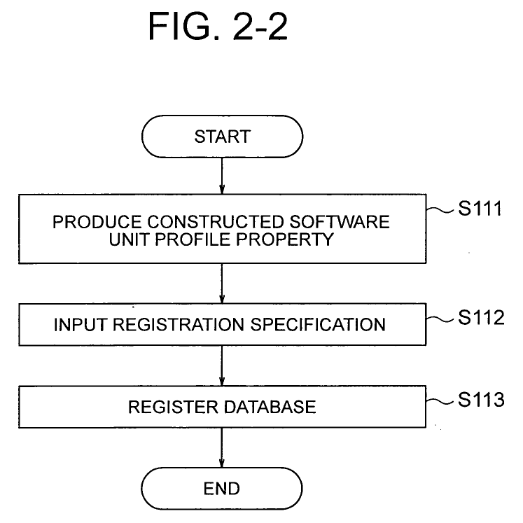

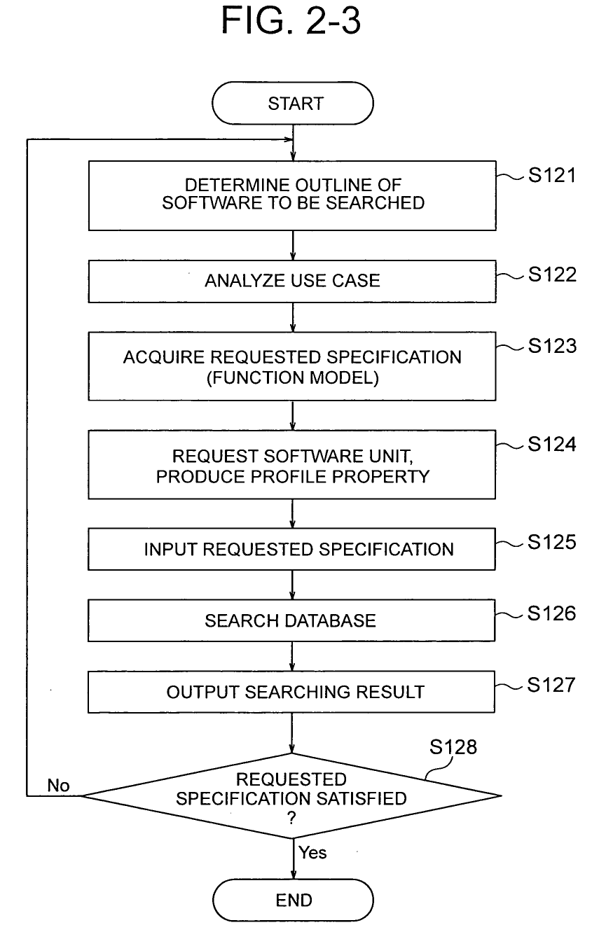

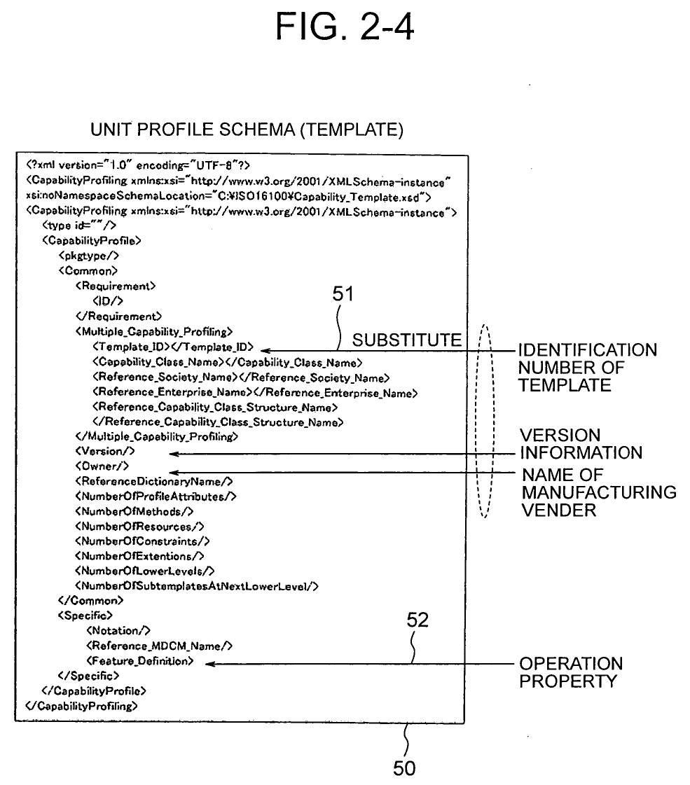

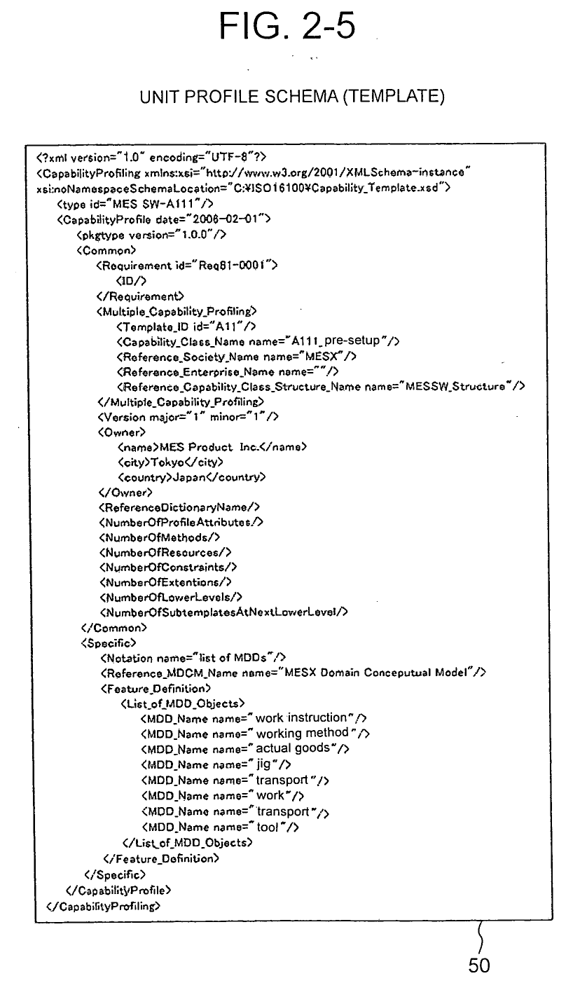

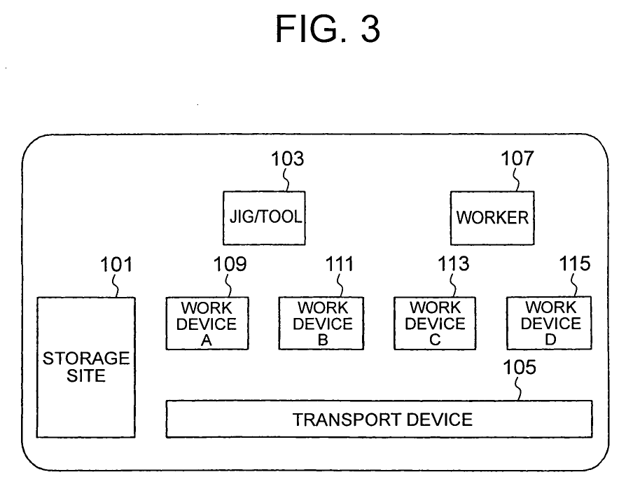

Subsequently, a description will be given of a retrieval method for the manufacturing industry software unit with the use of the retrieval device 1 according to this embodiment, structured as described above. FIG. 2-1 is a flowchart for explaining a flow of acquiring the domain concept data model. FIG. 2-2 is a flowchart for explaining a flow of registering the existing software unit in the retrieval device 1 according to this embodiment. FIG. 2-3 is a flowchart for explaining the retrieval process in the retrieval device 1 according to this embodiment.

First, the domain concept data model is acquired, which is to be the common semantics of a problem area correspondence in question. In this example, it is assumed that the software unit to be registered in the retrieval device 1 according to this embodiment is described on the basis of the unit profile schema (template) which is defined by ISO 16100-2 for describing the software unit profile. In addition, the software unit is property-described with the use of the activity as the specification to be implemented, and the property is described with the use of the given domain concept data model element which is accessed by the activity, or the activity of the middle level (lower level) which is implemented by being nested within the software unit. As a result, it is possible to effectively register and search for the semantics of a process of the existing manufacturing industry software unit and the embodied activity in a directly expressed and common format, as compared with an indirect system using the names or the like for specific management.

A method of acquiring the domain concept data model will be described with reference to a flowchart of FIG. 2-1. First, an arbitrary domain application system is selected (Step S101).

Then, a typical use case analysis in the selected domain application system is conducted (Step S102), a relationship between the domain concept data model elements that are abstracted from the manufacture information or the manufacture resource which is exchanged between the manufacture activities in the specific manufacture domain is estimated on the basis of the above analysis to thereby design the assumption of the domain concept data model (Step S103). In this situation, for example, consideration is given to adopting the past experience, the model or terminology determined according to the relevant international standards as the given limit.

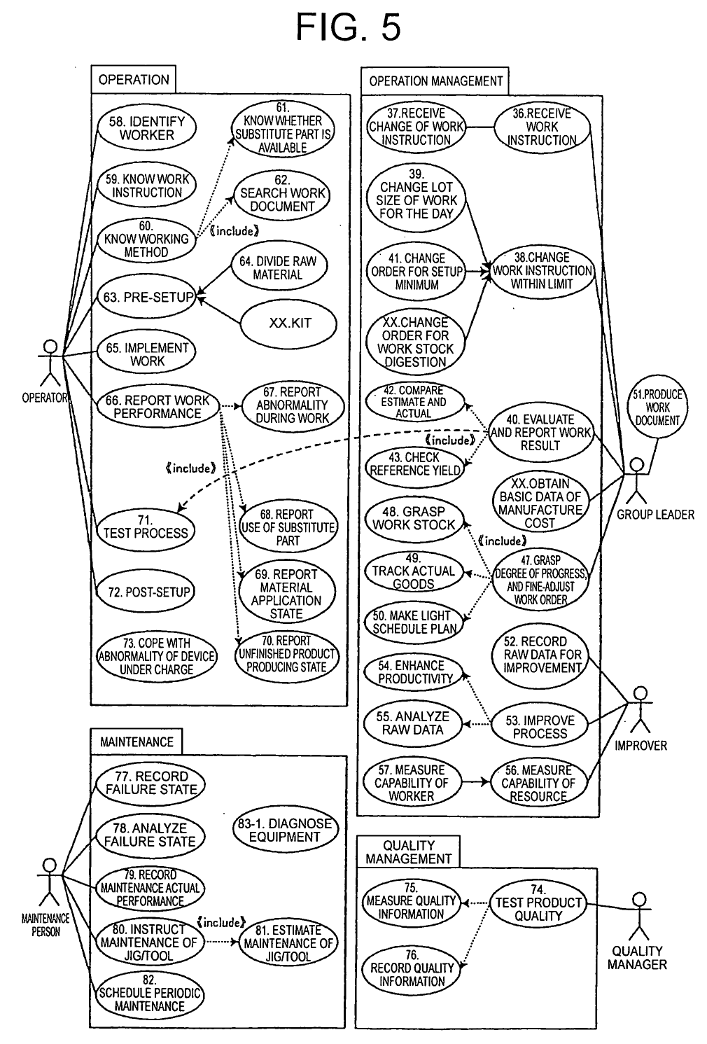

Then, a specific use case analysis in the selected domain application system is conducted to produce the domain use case drawing shown in FIG. 5 (Step S104). The use case analysis and the production of the domain use case drawing can be conducted with the use of the existing unified modeling language (UML), and therefore its detailed description will be omitted.

Then, the assumption of the domain concept model conducted in Step S103 is verified on the basis of the produced domain use case drawing (Step S105), and it is determined whether the assumption covers all the conceivable execution contents of the domain application system, or not (Step S106). In this situation, in the case where it is determined that the assumption does not cover all (“No” in Step S106), the assumption of the domain concept model is corrected (Step S107), and the processing is returned to Step S104 in which the use case analysis is satisfactorily repeated. Also, in the case where the assumption covers all (“Yes” in Step S106), the designed domain concept data model is ascertained, and the domain concept data model of the domain application system which is to be registered in the retrieval device 1 is acquired (Step S108).

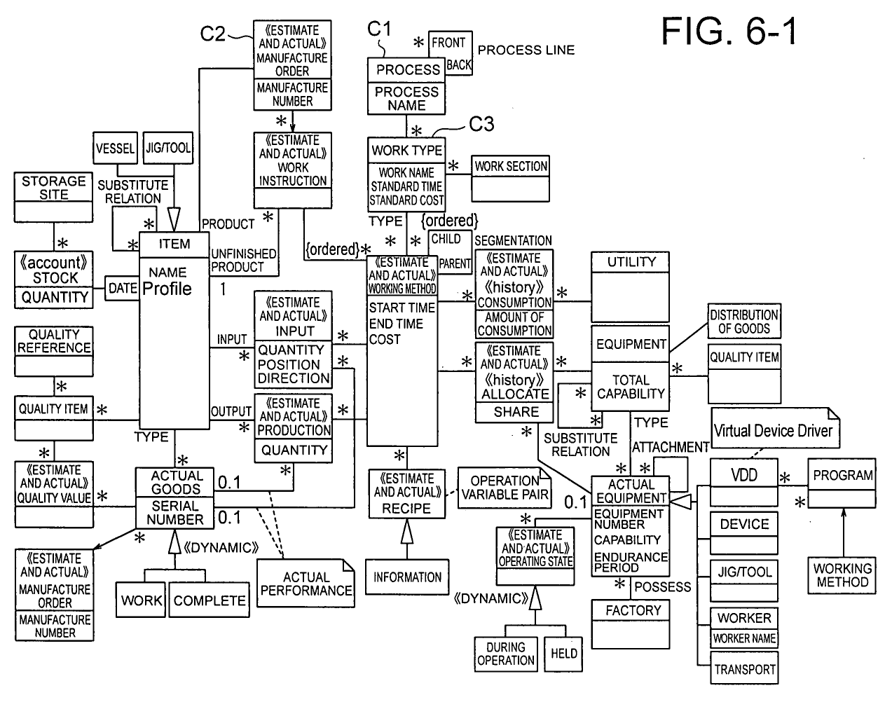

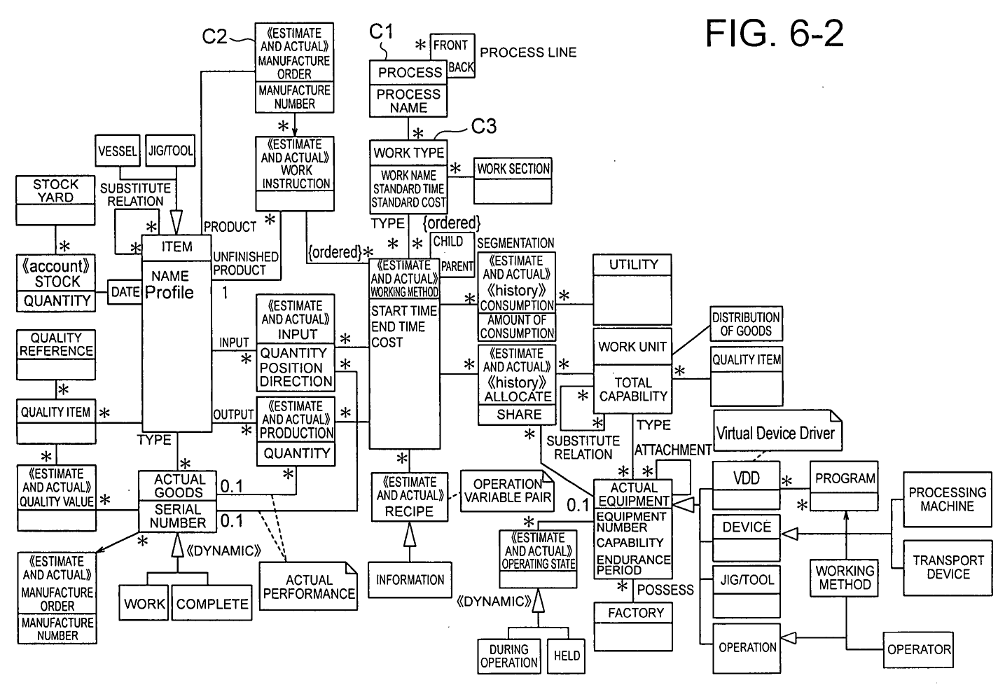

FIG. 6-1 shows an example of the acquired domain concept data model drawing. The acquired domain concept data model is the assembly of abstracted data types (e.g., object name, operation type, interface type, and variable type) that exist in a problem area and relations between those data types. The respective elements that are inscribed in a rectangle as function classes within the concept data model or the domain concept data model are domain concept data model elements.

The domain concept data model can be conducted with the use of the existing unified modeling language (UML), and therefore its detailed description will be omitted.

In this embodiment, as one embodiment of the manufacture form, a description will be given of a software unit that controls a production system including a storage site 101, a jig 103, a transport device 105, a worker 107, a work device A109, a work device B111, a work device C113, and a work device D115 as shown in FIG. 3.

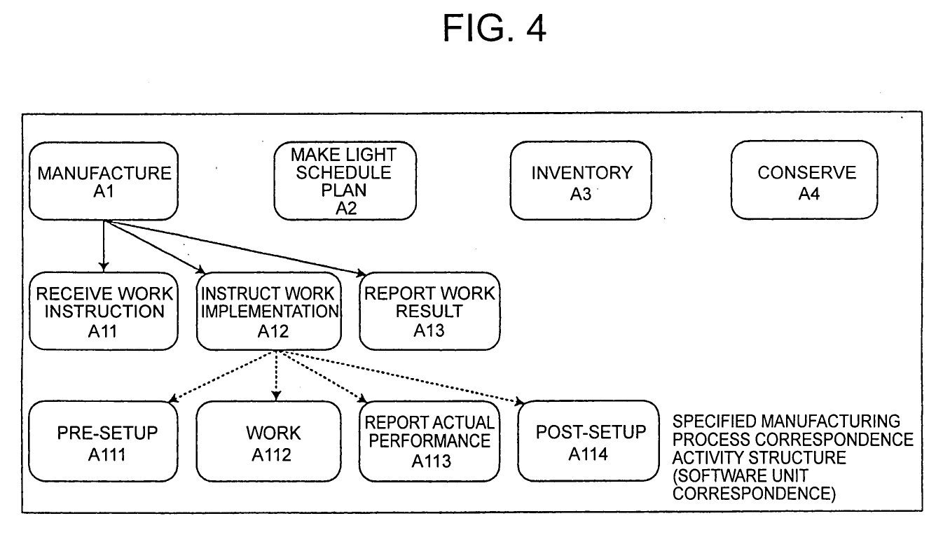

The manufacturing industry software unit of the production system thus structured is described with the use of the activity (i.e., activity model) of the implementation specification correspondence as shown in FIG. 4. In this case, for example, the software unit property can be described with the use of an activity A1 “manufacture”, an activity A2 “make a light schedule plan”, an activity A3 “inventory”, or an activity A4 “conserve” as the highest-level activity of the activity structure that is expressed by a tree structure as shown in FIG. 4.

Then, the high-level activity can be described by the assembly of the middle-level activities that have been finely developed. For example, an activity A1 “manufacture” which is the higher-level activity can be described as an assembly of an activity A11 “receive work instruction”, an activity A12 “instruct work implementation”, and an activity A13 “report work result” which are the middle-level activities that have been finely developed as shown in FIG. 4.

Further, the middle-level activity can be described by the assembly of the lower-level activities that have been finely developed. For example, an activity A12 “instruct work implementation” which is the middle-level activity can be described as an assembly of an activity A111 “pre-setup”, an activity A112 “work”, an activity A113 “report actual performance”, or an activity A114 “post-setup” which are the lower-level activities that have been finely developed as shown in FIG. 4.

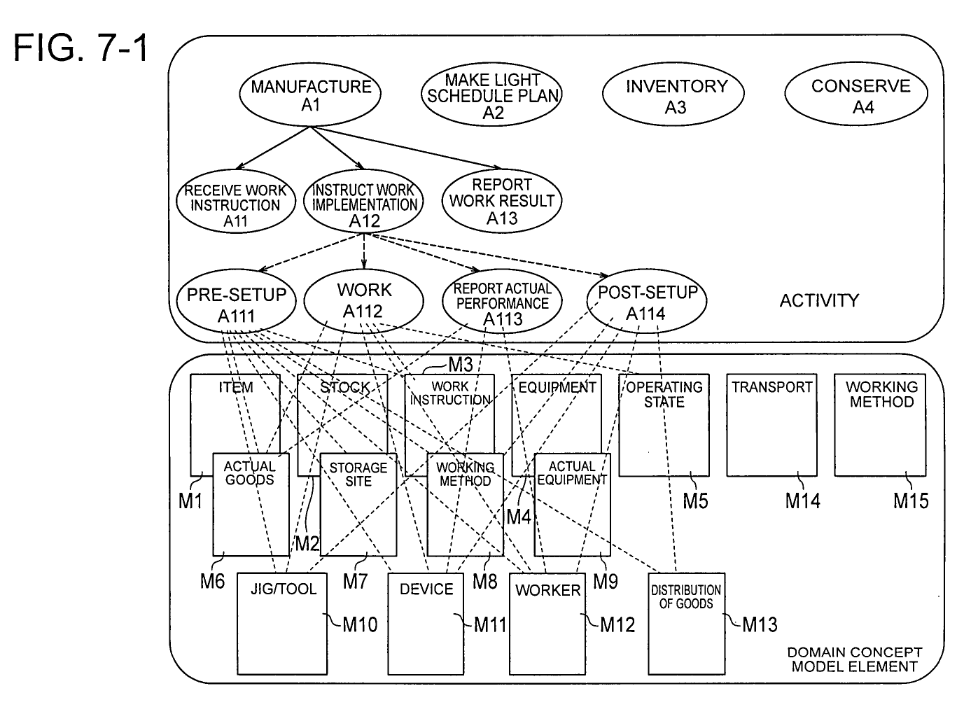

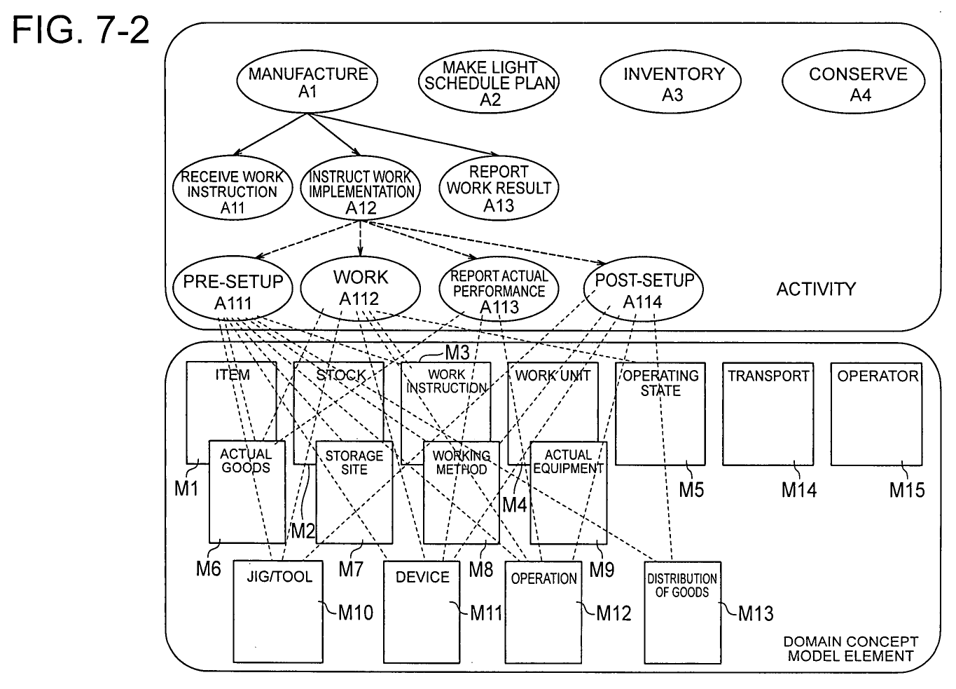

Then, in the software unit property of the software unit in the above production system, as shown in FIG. 7-1, the lower-level activity can be described by the assembly of the domain concept data model elements due to the common domain concept data model of the problem area.

For example, the activity A111 “pre-setup” that is the lower-level activity can be described as the assembly of an elements M10 “jig/tool”, M6 “actual goods”, M11 “device”, M7 “storage site”, M12 “worker”, M8 “working method”, M13 “distribution of goods”, and an element M3 “work instruction” which are domain concept data model elements that have been further finely developed. Likewise, the activity A112 “work” can be described as the assembly of the domain concept data model element M6 “actual goods”, M10 “jig/tool”, M12 “worker”, M3 “work instruction”, M1 “device”, and an element M5 “operating state”. Likewise, the activity A113 “report the actual performance” can be described with the use of the domain concept data model element M6 “actual goods”, M11 “device”, and an element M12 “worker”. Then, the activity A114 “post-setup” can be described as the assembly of the domain concept data model element M10 “jig/tool”, M8 “working method”, M11 “device”, M12 “worker”, and an element M13 “distribution of goods”.

Alternatively, as shown in FIG. 7-2, for example, the activity A111 “pre-setup” that is a lower-level activity can be described as the assembly of the elements M10 “jig/tool”, M6 “actual goods”, M11 “device”, M7 “storage site”, M12 “operation”, M8 “working method”, M13 “distribution of goods”, and the element M3 “work instruction” which are the domain concept data model elements that have been further finely developed. Likewise, the activity A112 “work” can be described as the assembly of the domain concept data model elements M6 “actual goods”, M10 “jig/tool”, M12 “operation”, M3 “work instruction”, M11 “device”, and the element M5 “operating state”. Likewise, the activity A113 “report actual performance” can be described with the use of the domain concept data model elements M6 “actual goods”, M11 “device”, and the element M12 “operation”. Then, the activity A114 “post-setup” can be described as the assembly of the domain concept data model elements M10 “jig/tool”, M8 “working method”, M11 “device”, M12 “operation”, and the element M13 “distribution of goods”.

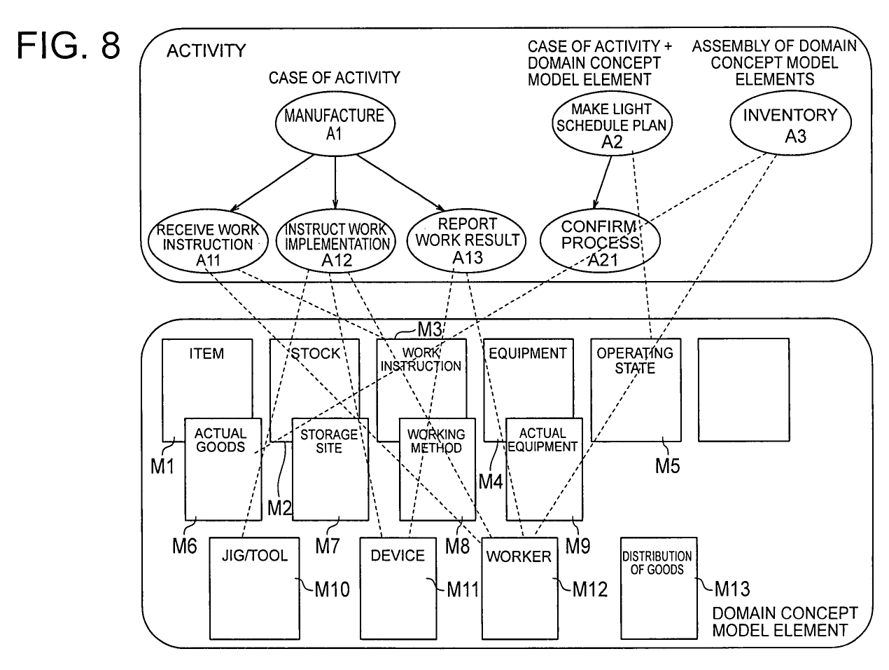

Also, the high-level activity, for example, can be described as the assembly of the middle-level activity and the domain concept data model element with the use of the middle-level activity and the domain concept data model element. For example, the activity A2 “make a light schedule plan” which is the higher-level activity can be described as the assembly of the activity A21 “confirm a process” which is the middle-level activity that has been finely developed as shown in FIG. 8, and the domain concept data model element M5 “operating state”.

In addition, for example, the activity can be described as the assembly of the domain concept data model elements with the use of only the domain concept data model elements. For example, the activity A3 “inventory” that is the higher-level activity can be described as the assembly of the domain concept data model element M6 “actual goods” and M12 “worker” as shown in FIG. 8.

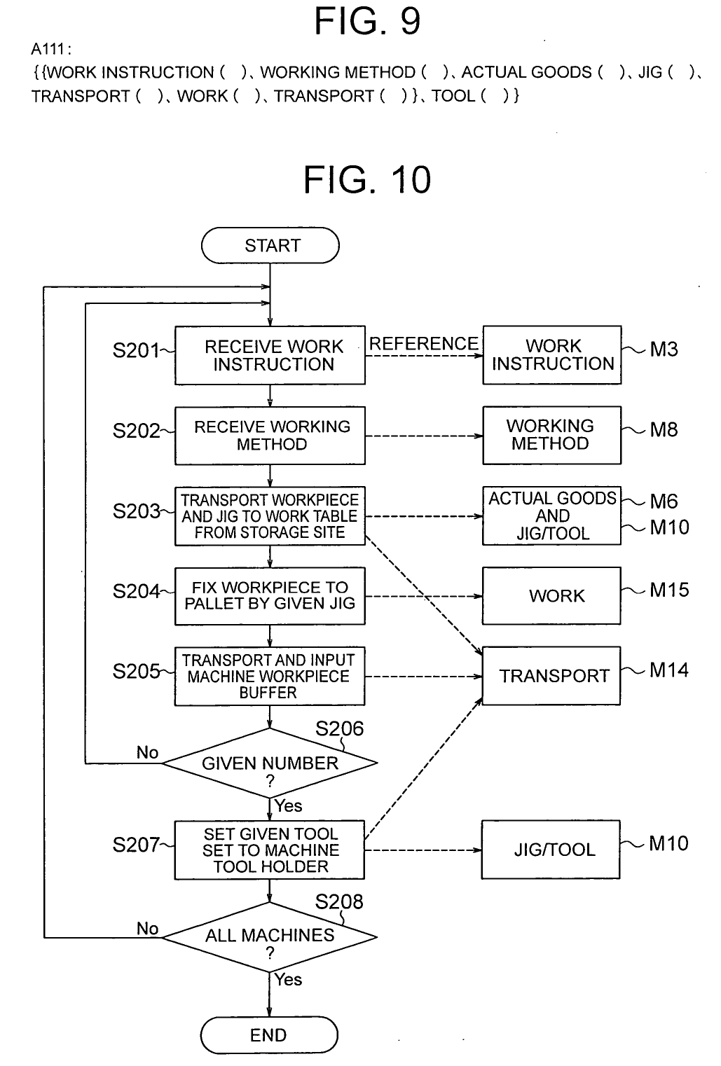

Then, the activity is capable of describing the property while referencing and describing the domain concept data model element by using a tag description language such as extensible markup language (XML), and the domain concept data model element as the XML schema description. In other words, the activity can be described as the list of the domain concept data model elements. For example, the activity 111 “pre-setup” of which the lower-level activity is shown in FIG. 7-1 can be property-described with the use of the domain concept data model element on the basis of XML as shown in FIG. 9.

In this example, in the property description of the activity A111 “pre-setup” shown in FIG. 9, the order of the domain concept data model elements are designated. As a result, the activity can be distinguished by the operation order. In FIG. 9, square brackets [ ] express, for example, a machine correspondence unit, curly brackets { } express a process unit, and round brackets ( ) express the insertion of arguments.

FIG. 10 is a diagram for explaining a property describing method with the action series of the activity A111 “pre-setup” shown in FIG. 9. In this case, first as shown in FIG. 10, a first action refers to the domain concept data model element M3 “work operation” (Step S201). Then, a second action refers to a domain concept data model element M8 “working method” (Step S202). Then, a third action refers to the domain concept data model element M6 “actual goods”, M10 “jig/tool”, and M14 “transport” (Step S203).

Then, a fourth action refers to the domain concept data model element M15 “work” (Step S204). Then, a fifth action refers to the domain concept data model element M14 “transport” (Step S205). In this example, it is confirmed whether a given number of workpieces have been transported or not (Step S206). In the case where the given number of workpieces have been transported (“Yes” in Step S206), and a sixth “jig/tool” (Step S207)

In this example, it is confirmed whether the above processes have been completed with respect to all machines, or not (Step S208), and in the case where the above processes have been completed with respect to all of machines (“Yes” in Step S208), the action series of the activity A111 “pre-setup” is completed.

Returning to Step S206, and in the case where the given number of workpieces have not been transported (“No” in Step S206), processing is returned to Step S201.

Returning to Step S208, and in the case where the above processes have not been completed with respect to all machines (“No” in Step S208), processing is returned to Step S201.

The property description of the activity A111 “pre-setup” as shown in FIG. 9 can be conducted on the basis of the above flow.

Then, a description will be given of a process of registering the existing software unit with reference to a flowchart of FIG. 2-2. First, the profile+ of the constructed existing software unit is produced (Step S111). That is, as shown in FIG. 2-4, the attributes defined by the template are substituted with the values of the manufacture vender name of the subject software unit, the version number of the software, or the identification number of the template to provide a profile description 51 by using the unit profile schema (i.e., template) 50 that is defined by ISO 16100-2 for defining the constructed existing software unit. In this event, the execution contents of the software unit is added to the profile as an operation property description 52 in the formally inscribed system due to the access contents to the subject domain concept data model. FIG. 2-5 is an example that profiles the above execution contents.

Therefore, in this situation, the profile of the software unit and the property are produced. As a result, the software unit to be registered can be described with the use of the software unit profile and the property which are described in the implementation specification format.

Then, the registered specification is inputted by the input section 11 (Step S112). In other words, the profile+ of the software unit to be registered is inputted. Then, the registering process that registers the software unit profile+ that has been inputted by the input section 11 in the database 17 is conducted in the registration section 13 (Step S113) In this example, the registration section 13 conducts the registering process after confirming whether an object to be registered is described in the given format, or not. Also, in the case where the software unit profile+ is not described in the given format, the registration section 13 transmits the information to the output section 21. In the case of receiving the information, the output section 21 outputs the information to a display device or a printing device which is connected to the output section 21. The display device or the printing device displays or prints the outputted information. With the above operation, the registration of the software unit profile+ in the database 17 is completed.

Then, a description will be given of a process of retrieving the software having a desired execution function (i.e., activity) from the existing software parts that are registered in the database 17. In the case where the software is retrieved, it is necessary to input the requested specification of the desired execution function (i.e., activity) through the input section 11.

In this example, the requested specification is described with the use of the domain concept data model as with the software unit profile+ that has been registered in the database 17. As a result, it is possible to input the process semantics of the requested specification in the directly expressed and common format. As a result, because the software unit that has been registered in the database 17 and the request specification are described in the identical formation, the comparison thereof can be smoothly conducted, and the retrieval can be smoothly and surely conducted.

Also, the requested specification can be also property-described with the use of the tag description language, for example, due to XML while the domain concept data model element is referenced and described as the XML schema description. As a result, because the software unit that has been registered in the database 17 and the request specification can be described in the identical formation, the retrieval can be smoothly and surely conducted.

Also, in producing the requested specification, as shown in FIG. 2-3, the outline of the software unit to be searched which has a desired execution function (i.e., activity) is first determined (Step S121). Then, the outline is analyzed with a use case fashion (Step S122), and the activity model of the requested specification is acquired (Step S123). In addition, the correspondence property description is obtained with the use of the domain concept data model element to be accessed by the activity, and the profile description due to the template defined by ISO 16100-2 is obtained (not described in detail), and the software unit request profile+ is produced (Step S124). As a result, the requested specification can be obtained in the directly expressed and common format. When the software unit request property is described with the use of the domain concept data model element, the order of the domain concept data model elements is designated, thereby making it possible to distinguish the requested specification by the working order, as shown in FIG. 6-1. Also, in the case where no order is designated, in the post retrieval process, it is possible to pick up all of the software units including the designated domain concept data model element.

Then, the requested specification obtained as described above is inputted by means of the input section 11 (Step S125). The inputted requested specification is transmitted to the searching section 15, and the searching section 15 receives the requested specification, and retrieves whether the software unit (or software part) which conforms to the requested specification has been registered in the database 17, or not, on the basis of the requested specification (Step S126).

In this example, in the case where the software unit (or the software parts) corresponding to the requested specification has been registered in the database 17, the searching section 15 picks up the corresponding data and outputs the data to the output section 21 (Step S127). In this situation, the searching section 15 is capable of picking up not only the software unit (or the software parts) that perfectly conforms to the requested specification, but also the software unit (or the software parts) corresponding to only a part of the requested specification, picking up the corresponding data, and outputting the data to the output section 21.

The output section 21 outputs the data to the display device or the printing device which is connected to the output section 21. The display device or the printing device displays or prints the outputted information As a result, the user is capable of obtaining a desired retrieval result. Then, the user confirms whether the retrieval result meets the requested specification, or not (Step S128), and in the case where the retrieval result meets the requested specification (“Yes” in Step S128), the user is capable of developing the software unit with the use of the results. Also, in the case where the retrieval result does not meet the requested specification (“No” in Step S128), the processing is returned to Step S121, and the outline of the software unit to be searched can be restudied on the basis of the results.

Also, in the case where the corresponding software unit (or the software parts) has not been registered in the database 17, the searching section 15 transmits the information that there is no subject various data to the concept data model schema management section 19. In the case of receiving the information on the fact that the software unit (or the software parts) corresponding to the requested specification has not been registered in the database 17 from the searching section 15, the concept data model schema management section 19 transmits the information that the subject data should be newly registered, to the output section 21 because data that conforms to the requested specification, that is, the concept data model element, and the activity embodied by the given middle-level (or lower-level) software unit do not exist in the database 17.

In the case of receiving the information that the data transmitted by the concept data model schema management section 19 should be newly registered, the output section 21 outputs the data to the display device or the printing device which is connected to the output section 21. The display device or the printing device displays or prints the outputted information. As a result, the user is capable of newly recognizing the necessity of the data registration.

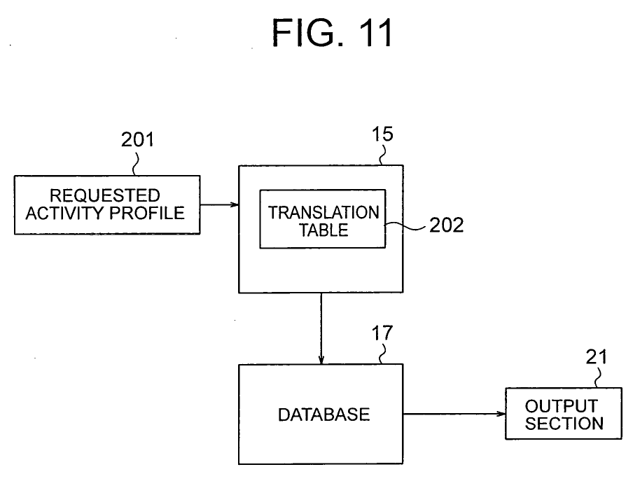

The searching section 15 may have a translation table that converts between the schemas which are described in different description formats. With the provision of the above translation table, even in the case where the requested activity profile and the property 201 which are described in the description format different from a normal case are inputted as shown in FIG. 11, the searching section 15 is capable of converting the description format into the normal domain concept data model with reference to the translation table 20, and is capable of increasing the degree of freedom of retrieval.

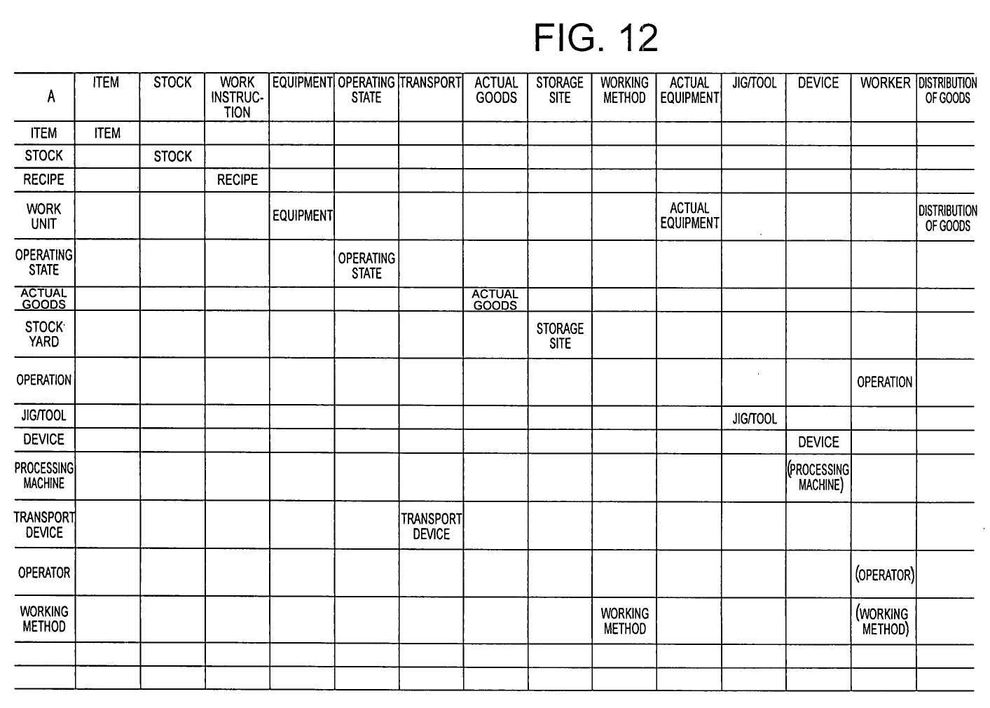

An example of the translation table is shown in FIG. 12. The description contents of the translation table expresses mutual conversion between the different description formats of the description contents of the concept data model shown in FIG. 6-1 and FIG. 6-2. In other words, “storage side” of the model elements in the example of FIG. 6-1 is substituted with “stock yard”, “equipment” with “work unit”, “worker” with “operation”, and its abstract class “operator” with “operating method”, and “device” with its abstract class “processing machinery” and “transport device”. The translation table shown in FIG. 12 is an example of a conversion table that enables the mutual conversion.

As described above, according to the retrieval device 1 of this embodiment, in the registration of the existing software unit, the unit schema for defining the software unit is described with the use of the software unit profile described in the implementation specification format. That is, the software unit can be described with the use of the software unit profile that is described in the implementation specification format. Also, a request in conducting retrieval can be described with the use of the same format. As a result, the process semantics of the existing application software unit is efficiently registered in the directly expressed and common format, and the registered application software unit can be efficiently retrieved.

As described above, the retrieval device of the manufacturing industry software unit according to the present invention is useful in a case where the number of software parts which is newly developed is deleted, and the existing software parts is employed in order to improve the efficiency of development of the manufacturing industry software unit. In particular, the retrieval device of the manufacturing industry software unit according to the present invention is suitable for retrieval in the case of developing the manufacturing industry software unit that controls a large-sized system such as a flexible production system.

1. An apparatus for searching for a software unit for use in the manufacturing industry, comprising:
input means for inputting one of a manufacturing industry software unit and a required specification to be retrieved which are described as a software unit profile of the implementation specification form and the software unit property, which share the domain concept data model of the specified field as the semantics and use the model element of the domain concept data model;
memory means for storing the software unit profile and the software unit property of the manufacturing industry software unit which are inputted;
retrieval means for retrieving and extracting the manufacturing industry software unit that conforms to the requested specification from the memory means; and
output means for outputting the retrieval result in the retrieval means to the external.

2. The apparatus for searching for a software unit for use in the manufacturing industry according to claim 1, wherein the property of the activity based on one of the manufacturing industry software unit and the requested specification is defined as an assembly of the model elements of the domain concept data model of the specified field.

3. The apparatus for searching for a software unit for use in the manufacturing industry according to claim 1, wherein the property of the activity based on one of the manufacturing industry software unit and the requested specification is defined as an assembly of the model elements of the domain concept data model of the specified field, the order of the model elements being designated.

4. The apparatus for searching for a software unit for use in the manufacturing industry according to claim 1, wherein the property of the activity based on one of the manufacturing industry software unit and the requested specification includes an access argument of the model elements of the domain concept data model of the specified field.

5. The apparatus for searching for a software unit for use in the manufacturing industry according to claim 1, wherein the property of the activity based on one of the manufacturing industry software unit and the requested specification is defined as an assembly of the activities that have been finely developed.

6. The apparatus for searching for a software unit for use in the manufacturing industry according to claim 1, wherein the property of the activity based on one of the manufacturing industry software unit and the requested specification is described by an XML on the basis of the domain concept data model of the specified field.

7. The apparatus for searching for a software unit for use in the manufacturing industry according to claim 1, wherein the process of the requested specification is defined using the model elements of the domain concept data model of the specified field.

8. The apparatus for searching for a software unit for use in the manufacturing industry according to claim 1, wherein the property of the requested specification is described on the basis of the XML as the assembly of the model elements of the domain concept data model of the specified field.

9. The apparatus for searching for a software unit for use in the manufacturing industry according to claim 1, wherein the retrieval means includes a translation table for converting the requested specification that is described in the implementation specification format different from the model element of the domain concept data model of the specified field to the same implementation specification format as the model element of the domain concept data model of the specified field, and converts the implementation specification format of the requested specification with reference to the translation table.

10. A method for searching for a software unit for use in the manufacturing industry, comprising the steps of:
acquiring an execution procedure model of a specified field;
describing the manufacturing industry software unit as a software unit profile of the implementation specification format and the software unit property on the basis of the domain concept data model;
describing the requested specification to be retrieved in the implementation specification format on the basis of the domain concept data model; and
comparing the requested specification described in the implementation specification format with the manufacturing industry software unit described as the software unit profile of the implementation specification format, and retrieving and extracting the manufacturing industry software unit that conforms to the requested specification.
